(19) United States
(12) Patent Application Publication
(10) Pub. No.: US 2026/0301694 A1
(43) Pub. Date: Oct. 1, 2026

(54) DISPLAY DEVICE

(71) Applicant: Sharp Display Technology Corporation, Kameyama City, Mie (JP)

(72) Inventors: Hiroyuki FURUKAWA, Kameyama City (JP); Masafumi UENO, Kameyama City (JP)

(21) Appl. No.: 19/163,141

(22) PCT Filed: Mar. 10, 2023
(86) PCT No.: PCT/JP2023/009379

§ 371 Date: Sep. 8, 2025

(51) Int. Cl. G09G 3/3275

(52) U.S. Cl. CPC G09G 3/3275; G09G 2310/027; G09G 2320/0233; G09G 2320/0271

(57) ABSTRACT

Provided is a display device including a display portion and a control unit configured to control the display portion. The display portion a subpixel including a first light-emitting region and a second light-emitting region. When a gray scale greater than zero gray scale and less than a threshold gray scale is input to the subpixel, the control unit causes the first light-emitting region to emit light without causing the second light-emitting region to emit light. When a gray scale equal to or greater than the threshold gray scale is input to the subpixel, the control unit causes the first light-emitting region and the second light-emitting region to emit light.

### TECHNICAL FIELD

The disclosure relates to a display device.

### BACKGROUND ART

In a display device, when the gray scale value of each subpixel is low, the luminance control of the subpixel becomes unstable, and the display quality may be degraded. The above-described problem becomes more significant in a display device including a self-light-emitting element such as an organic light-emitting element (OLED element) or a quantum dot light-emitting element (QLED element), for example, for each subpixel. This is because the luminance of the light-emitting element generally becomes unstable when the self-light-emitting element is driven with a low current such as a current near the light emission threshold current. PTL 1 discloses a display device that performs stable display even at low gray scales by switching the driving method for a light-emitting element in low gray scale display.

### CITATION LIST

### Patent Literature

PTL 1: JP 2001-109421 A

### SUMMARY

### Technical Problem

In a display device that switches the method of light emission control for each subpixel such as the display device described in PTL 1, the number of transistors, capacitors, and the like necessary for light emission control of each subpixel increases, which causes an increase in cost and a reduction in light-emitting area. In addition, in the display device, since a plurality of light emission control methods are used, light emission control of each subpixel becomes complex.

### Solution to Problem

A display device according to an aspect of the disclosure includes: a display portion including a subpixel including a first light-emitting region and a second light-emitting region; and a control unit configured to control the display portion to cause the second light-emitting region to not emit light and to cause the first light-emitting region to emit light in a case where a gray scale greater than a zero gray scale and less than a threshold gray scale is input to the subpixel and to cause the first light-emitting region and the second light-emitting region to emit light in a case where a gray scale equal to or greater than the threshold gray scale is input to the subpixel.

### Advantageous Effects of Disclosure

A display device can perform low gray scale display more stably while reducing an increase in cost, a reduction in light-emitting area, and complexity in light emission control of each subpixel.

### BRIEF DESCRIPTION OF DRAWINGS

FIG. 1 is a schematic view of a display device according to a first embodiment and a schematic view of a light-emitting region.

FIG. 2 is a schematic plan view of the display device according to the first embodiment.

FIG. 3 is a schematic cross-sectional view of a display panel according to the first embodiment.

FIG. 4 is a graph illustrating a relationship between gray scale values and luminance of a subpixel according to the first embodiment.

FIG. 5 is a graph illustrating a relationship between gray scale values and luminance of each light-emitting region according to the first embodiment.

FIG. 6 is a schematic view of a display device according to a second embodiment and a schematic view of a light-emitting region.

FIG. 7 is a schematic view of a display device according to a third embodiment.

### DESCRIPTION OF EMBODIMENTS

### First Embodiment

### Display Device: Overview

Embodiments of the disclosure will be described below with reference to the drawings. In each drawing, the same components are denoted by the same reference numerals and signs, and description thereof is omitted.

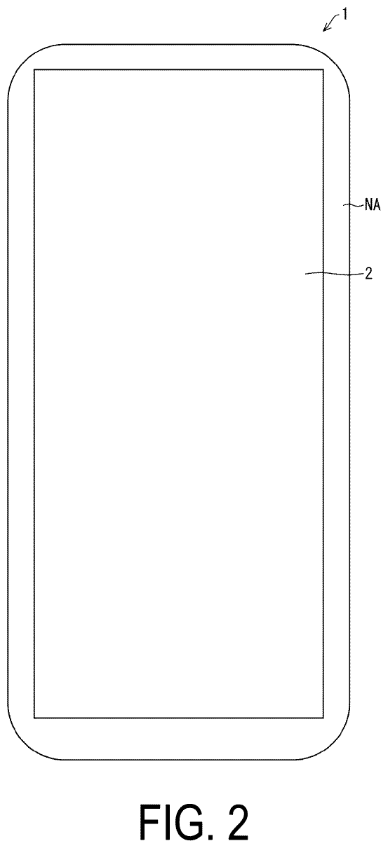

FIG. 2 is a schematic plan view of a display device 1 according to the present embodiment. The display device 1 is a device that can be used as a display of, for example, a television, a smartphone, or the like. The display device 1 includes a display portion 2 and a frame portion NA formed around the display portion 2. The display device 1 performs display in the display portion 2 by controlling light emission from each of a plurality of subpixels described below formed in the display portion 2. In the frame portion NA, a driver (described below) for controlling light emission in each of the plurality of subpixels of the display portion 2 is formed.

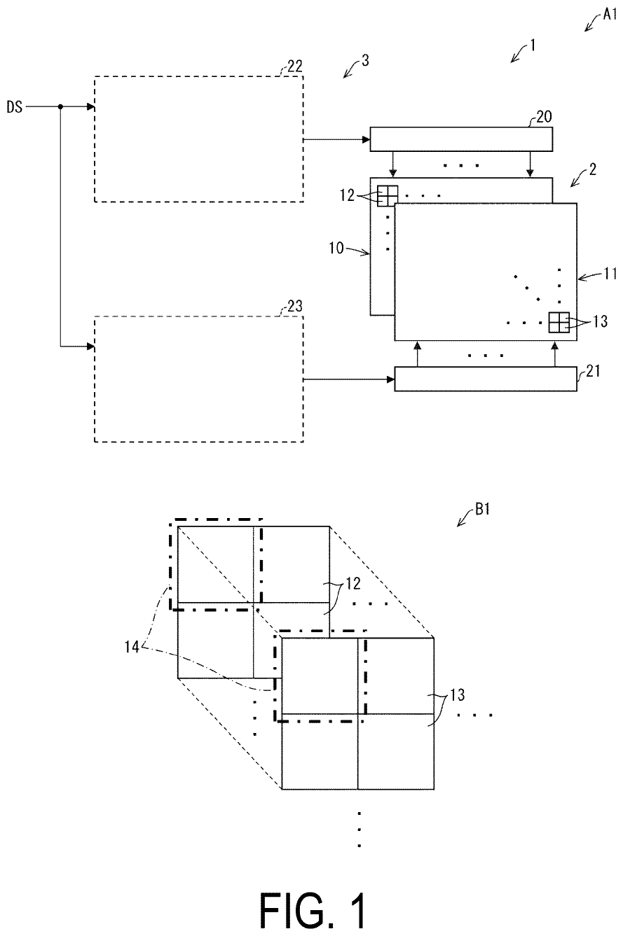

The configuration of each unit of the display device 1 according to the present embodiment will be described in detail with reference to FIG. 1. FIG. 1 illustrates a schematic view Al of the display device 1 and a schematic view B1 of a light-emitting region described later. As illustrated in the schematic view A1, the display device 1 according to the present embodiment includes the display portion 2 described above and a control unit 3 formed in the frame portion NA described above, for example.

### Display Device: Display Portion: Display Panel and Light-Emitting Element

The display portion 2 according to the present embodiment includes a lower display panel 10 and an upper display panel 11 located more to the viewing side of the display portion 2 than the lower display panel 10. A plurality of first light-emitting regions 12 arranged two dimensionally are formed on the lower display panel 10, and a plurality of second light-emitting regions 13 arranged two dimensionally are formed on the upper display panel 11. For example, in schematic view B1, a portion of the first light-emitting regions 12 of the lower display panel 10 and a portion of the second light-emitting region 13 of the upper display panel 11 are extracted and illustrated.

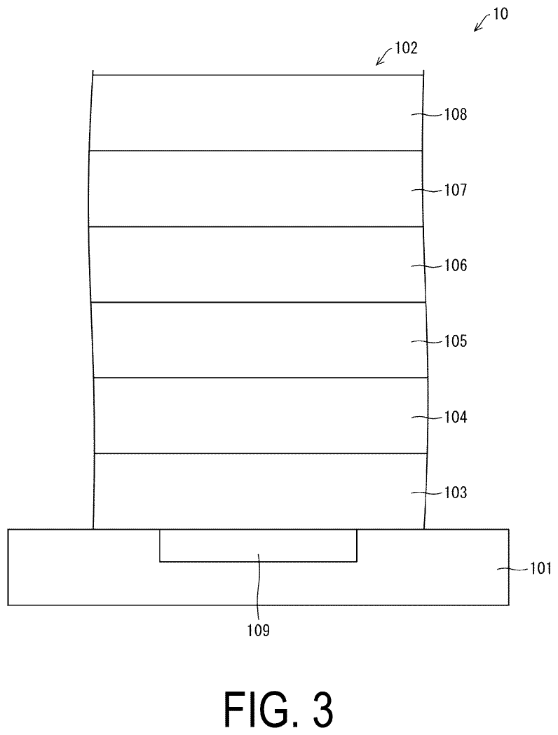

Each of the lower display panel 10 and the upper display panel 11 according to the present embodiment include a light-emitting element that emits light to the viewing side of the display portion 2 in each of the first light-emitting regions 12 and the second light-emitting regions 13. For a detailed description of the light-emitting element according to the present embodiment, each of the lower display panel 10 and the upper display panel 11 will be described in more detail with reference to FIG. 3. FIG. 3 is a schematic cross-sectional view illustrating, of the display panels included in the display portion 2, the lower display panel 10.

As illustrated in FIG. 3, the lower display panel 10 includes a substrate 101 and a light-emitting element 102 formed on the substrate 101. In particular, the lower display panel 10 includes the light-emitting element 102 in each first light-emitting region 12.

The light-emitting element 102 includes, for example, an anode 103 as a first electrode, a hole injection layer 104, a hole transport layer 105, a light-emitting layer 106, an electron transport layer 107, and a cathode 108 as a second electrode in this order from the substrate 101 side. Note that the structure of the light-emitting element 102 is not limited to the structure described above, and the light-emitting element 102 may include the cathode 108, the electron transport layer 107, the light-emitting layer 106, the hole transport layer 105, the hole injection layer 104, and the anode 103 in this order from the substrate 101 side. The light-emitting element 102 does not necessarily include at least one of the hole injection layer 104, the hole transport layer 105, and the electron transport layer 107 as long as at least the light-emitting layer 106 is provided between the anode 103 and the cathode 108. In other words, the light-emitting element 102 includes function layers including at least the light-emitting layer 106 between the anode 103 and the cathode 108. Further, the light-emitting element 102 may further include function layers including an electron injection layer between the electron transport layer 107 and the cathode 108, for example.

The substrate 101 includes a pixel circuit 109 including a transistor and the like in each first light-emitting region 12. Each pixel circuit 109 is electrically connected to the anode 103 of the light-emitting element 102 located in the corresponding first light-emitting region 12. In addition, each pixel circuit 109 applies a voltage to the anode 103 through control by a driver described later to generate a potential difference between the anode 103 and the cathode 108.

In each of the light-emitting elements 102 to which a voltage is applied, holes are injected from the anode 103 into the light-emitting layer 106 through the hole injection layer 104 and the hole transport layer 105, and electrons are injected from the cathode 108 into the light-emitting layer 106 through the electron transport layer 107.

The light-emitting layer 106 contains a light-emitting material that emits light via excitons generated by recombination of injected holes and electrons. In the present embodiment, the light-emitting layer 106 may be an organic light-emitting layer containing an organic light-emitting material or a quantum dot light-emitting layer containing light-emitting quantum dots (semiconductor nanoparticles).

Thus, a potential difference is generated between the anode 103 and the cathode 108 of the light-emitting element 102, and thus the light-emitting layer 106 emits light via holes injected from the anode 103 and electrons injected from the cathode 108. One of the anode 103 and the cathode 108 on the viewing side of the display portion 2 is a transmissive electrode having light transmissivity, and the light-emitting element 102 extracts light generated from the light-emitting layer 106 to the transmissive electrode side. Thus, the lower display panel 10 performs display by individually extracting light from each of the light-emitting elements 102.

Examples of a method for manufacturing the lower display panel 10 according to the present embodiment include a method for sequentially forming the layers of the light-emitting element 102 on the substrate 101. The method for forming each layer of the light-emitting element 102 may be appropriately determined according to the material of each layer, and each layer may be formed by using, for example, film formation by a sputtering method, separately patterning by applying, film formation by vapor deposition, patterning of a coating film by a photolithography method, or the like.

The upper display panel 11 according to the present embodiment has the same configuration as the lower display panel 10 and, in particular, includes the same light-emitting elements in each second light-emitting region 13 as the light-emitting element 102 included in the lower display panel 10. The upper display panel 11 includes, on the substrate 101, a pixel circuit 109 for controlling light emission of each light-emitting element 102 included in the upper display panel 11.

Thus, the lower display panel 10 includes the pixel circuit 109 as a first pixel circuit that controls light emission in the first light-emitting regions 12, and the upper display panel 11 includes the pixel circuit 109 as a second pixel circuit that controls light emission in the second light-emitting regions 13. Accordingly, the display device 1 realizes control of the light emission in each first light-emitting region 12 and control of the light emission in each second light-emitting region 13 via independent pixel circuits, and thus the control of the light emission in each light-emitting region is simplified.

Each of the lower display panel 10 and the upper display panel 11 includes, for example, a plurality of source signal lines and a plurality of gate signal lines, and the pixel circuit 109 is formed at or near an intersection point of the source signal line and the gate signal line. For example, the source signal line is connected to a source electrode of the transistor of the pixel circuit 109, and the gate signal line is connected to a gate electrode of the transistor of the pixel circuit 109. The anode 103 of the light-emitting element 102 is connected to a drain electrode of the transistor of the pixel circuit 109. Note that, in the drawings of the disclosure including FIG. 1, illustration of source signal lines, gate signal lines, and transistors of each display panel is omitted for simplification of illustration.

### Display Device: Display Portion: Subpixel

Referring back to FIG. 1, in the present embodiment, each first light-emitting region 12 is layered with the corresponding second light-emitting region 13 in the viewing direction of the display portion 2. For example, each of the first light-emitting regions 12 and each of the second light-emitting regions 13 illustrated in schematic view B1 are located at positions overlapping one another in the viewing direction of the display portion 2.

In the display portion 2 according to the present embodiment, a set including the first light-emitting region 12 and the second light-emitting region 13 layered on each other as indicated by a dot-dash line in schematic view B1 corresponds to a subpixel 14. Thus, the display portion 2 includes a plurality of the subpixels 14 arranged two dimensionally, and each subpixel 14 includes a first light-emitting region 12 and a second light-emitting region 13 located more to the viewing side of the display portion 2 than the first light-emitting region 12.

The display portion 2 performs display by controlling the intensity of light for each subpixel 14 by a method described later while extracting light from the first light-emitting region 12 and the second light-emitting region 13 of each subpixel 14 to the viewing side. In particular, the display portion 2 extracts light from the first light-emitting region 12 that has passed through the second light-emitting region 13.

The first light-emitting region 12 and the second light-emitting region 13 included in each subpixel 14 may have the same luminescent color. For example, the first light-emitting region 12 and the second light-emitting region 13 included in each subpixel 14 may include the same light-emitting material.

The display portion 2 may include a plurality of pixels each including the plurality of subpixels 14 having different luminescent colors. In this case, the pixel may include, as the subpixels 14, a red subpixel that emits red light, a green subpixel that emits green light, and a blue subpixel that emits blue light. The red subpixel, the green subpixel, and the blue subpixel may include a red light-emitting element that emits red light, a green light-emitting element that emits green light, and a blue light-emitting element that emits blue light, respectively, as the light-emitting elements 102 formed in the first light-emitting region 12 and the second light-emitting region 13.

### Display Device: Control Unit: Driver

The control unit 3 controls display by the display portion 2 by causing the display portion 2 to display an image corresponding to an image signal based on a data signal DS generated from the image signal received by a reception unit or the like (not illustrated) such as an antenna.

For example, the control unit 3 controls signal application to the source signal lines and the gate signal lines described above in each of the lower display panel 10 and the upper display panel 11. Thus, the control unit 3 controls the light emission of each light-emitting element 102 by individually controlling the voltage application to the anode 103 via the drain electrode of each pixel circuit 109 of the lower display panel 10 and the upper display panel 11.

The control unit 3 includes, for example, a first source driver 20, a second source driver 21, first gray scale converter 22, and second gray scale converter 23.

The first source driver 20 is connected to each source signal line of the lower display panel 10 and controls signal application to each source signal line. The second source driver 21 is connected to each source signal line of the upper display panel 11 and controls signal application to each source signal line. In particular, the first source driver 20 and the second source driver 21 control the strength of the signal applied to each source signal line in accordance with the luminance of each light-emitting region and the corresponding gray scale value. The control unit 3 includes a gate driver (not illustrated) that controls signal application to the gate signal line of the lower display panel 10 and the upper display panel 11.

In the present embodiment, the first source driver 20 applies a signal to each source signal line of the lower display panel 10 on the basis of a signal from the first gray scale converter 22. The second source driver 21 applies a signal to each source signal line of the upper display panel 11 on a basis of a signal from the second gray scale converter 23.

In particular, the first source driver 20 and the second source driver 21 generate signals to be applied to the respective source signal lines on the basis of data of the gray scale values of the respective light-emitting regions included in the input data signal DS. Thus, the control unit 3 controls the luminance of each light-emitting region via first source driver 20 and second source driver 21.

### Display Device: Control Unit: Gray Scale Value and Luminance in Light-Emitting Region

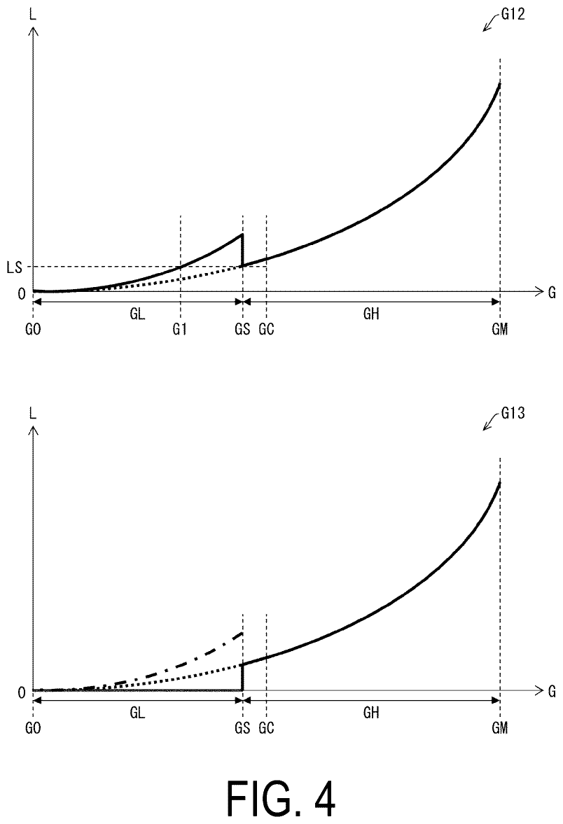

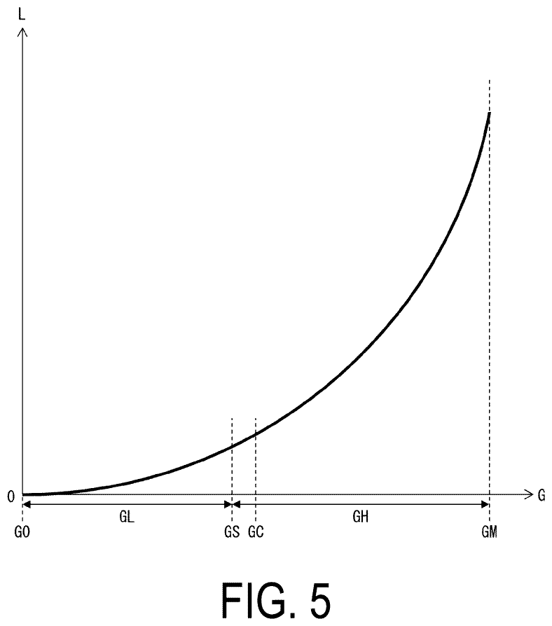

Here, the relationship between the gray scale value and the luminance with respect to each subpixel 14 and each first light-emitting region 12 and each second light-emitting region 13 corresponding to the respective subpixel 14 will be described in detail with reference to FIGS. 4 and 5. FIG. 4 is a graph G12 illustrating a relationship between the gray scale value and the luminance in the first light-emitting region 12 by a solid line, and a graph G13 illustrating a relationship between the gray scale value and the luminance in the second light-emitting region 13 by a solid line. FIG. 5 is a graph illustrating a relationship between the gray scale value and the luminance in each subpixel 14. In each graph in FIGS. 4 and 5, the horizontal axis represents the gray scale value and the vertical axis represents luminance. The values indicated by the dotted line and the dot-dash line in each graph of FIG. 4 will be described in detail later.

The control unit 3 determines a gray scale value corresponding to a necessary luminance for each subpixel 14 according to the received image signal. The control unit 3 inputs a signal corresponding to the gray scale value to the light-emitting element 102 of each of the first light-emitting region 12 and the second light-emitting region 13 corresponding to each subpixel 14 via each of the drivers. The luminance of the light-emitting element 102 of each subpixel 14 is controlled on the basis of the gray scale value input to each subpixel 14.

Hereinafter, in the present specification, the gray scale value input to the subpixel 14 may be simply referred to as the gray scale value of the subpixel 14. In the present specification, the terms “gray scale value of the first light-emitting region 12” and “gray scale value of the second light-emitting region 13” may be used as gray scale values input to the subpixels 14 including the first light-emitting region 12 or the second light-emitting region 13.

The luminance of each of the first light-emitting regions 12 and the second light-emitting regions 13 is controlled by a signal applied to the light-emitting element 102 included in each light-emitting region and in particular by a current value of the signal, for example. Thus, the higher the luminance of each of the first light-emitting regions 12 and each of the second light-emitting regions 13, the larger the current applied to the light-emitting element 102 included in each light-emitting region.

### Display Device: Control Unit: Low Gray Scale Range and High Gray Scale Range

Here, a threshold gray scale GS illustrated in graph G12 and graph G13 is set in advance for each subpixel 14. The threshold gray scale GS is greater than a zero gray scale G0 and less than the central gray scale GC of the input gray scale range excluding the zero gray scale G0. In the present specification, a gray scale range from equal to or greater than the threshold gray scale GS to equal to or less than a maximum gray scale GM is referred to as a high gray scale range GH, and a gray scale range from greater than the zero gray scale G0 to less than the threshold gray scale GS is referred to as a low gray scale range GL. When the gray scale value of the subpixel 14 is the zero gray scale G0, the luminance of the subpixel 14 is zero, and in particular, both the first light-emitting region 12 and the second light-emitting region 13 included in the subpixel 14 do not emit light.

As illustrated in graph G12 of FIG. 4, each first light-emitting region 12 is driven to emit light when the gray scale value of the corresponding subpixel 14 is in the input gray scale range greater than the zero gray scale G0 and equal to or less than the maximum gray scale GM. In particular, as illustrated in graph G12, in each of the low gray scale range GL and the high gray scale range GH, each first light-emitting region 12 is driven so that the luminance increases as the gray scale value of the corresponding subpixel 14 increases.

Here, the luminance change ratio of the first light-emitting region 12 corresponding to the low gray scale range GL is larger than the luminance change ratio of the first light-emitting region 12 corresponding to the high gray scale range GH. For example, the hypothetical values of luminance with respect to the gray scale values of each first light-emitting region 12 are indicated by dotted lines in graph G12, represent a case in which it is assumed that all of the input gray scale values are in the high gray scale range GH. As is clear from graph G12, the ratio of the increase in luminance to the increase in gray scale value in the low gray scale range GL of each first light-emitting region 12 is greater than the ratio of the increase in the hypothetical value described above.

The luminance of the first light-emitting region 12 at the threshold gray scale GS is less than the luminance of the first light-emitting region 12 at a predetermined gray scale in the low gray scale range GL. For example, as illustrated in graph G12, the gray scale value of the first light-emitting region 12 at the threshold gray scale GS is taken as a luminance LS. In this case, the luminance of the first light-emitting region 12 is the luminance LS at a first gray scale G1 of the low gray scale range GL. As described above, in the low gray scale range GL, the luminance of the first light-emitting region 12 increases as the gray scale value of the first light-emitting region 12 increases. Thus, the luminance of the first light-emitting region 12 is greater than the luminance LS at a gray scale higher than the first gray scale G1 in the low gray scale range GL.

In contrast, as illustrated in graph G13 of FIG. 4, each second light-emitting region 13 is driven to emit light when the gray scale value of the corresponding subpixel 14 is equal to or greater than the threshold gray scale GS, in other words, when the gray scale value of the corresponding subpixel 14 is in the high gray scale range GH. In particular, as illustrated in graph G13, when the gray scale value of the corresponding subpixel 14 is in the high gray scale range GH, each second light-emitting region 13 is driven so that the luminance increases as the gray scale value increases. On the other hand, when the gray scale value of the corresponding subpixel 14 is in the low gray scale range GL, each second light-emitting region 13 is driven so that the luminance is 0 regardless of the gray scale value. In other words, when the gray scale value is in the low gray scale range GL, each second light-emitting region 13 is driven so as not to emit light. Thus, as illustrated in graph G13, the luminance actually obtained from the second light-emitting region 13 is less than the hypothetical luminance described above at any gray scale in the low gray scale range GL.

Note that the luminance change ratio of the first light-emitting region 12 corresponding to the low gray scale range GL is larger than the luminance change ratio of the second light-emitting region 13 corresponding to the high gray scale range GH. For example, the hypothetical values of luminance with respect to the gray scale values of each second light-emitting region 13 are indicated by dotted lines in graph G13, represent a case in which it is assumed that all of the input gray scale values are in the high gray scale range GH. The luminance values of the first light-emitting regions 12 in the low gray scale range GL with respect to the gray scale values are indicated by the dot-dash line in graph G13. In this case, as is clear from graph G13, the ratio of the increase in luminance to the increase in gray scale value in the low gray scale range GL of each first light-emitting region 12 is greater than the ratio of the increase in the hypothetical value described above in each second light-emitting region 13.

### Display Device: Control Unit: Gray Scale Value and Luminance in Subpixel

The intensity of light obtained from each subpixel 14 is the intensity of light obtained by combining light from each first light-emitting region 12 and light from each second light-emitting region 13. However, the light obtained from the first light-emitting region 12 is attenuated according to the transmittance of the upper display panel 11. Thus, the luminance value of each subpixel 14 with respect to the gray scale value illustrated in the graph of FIG. 5 corresponds to, for example, a value obtained by adding a value obtained by multiplying the luminance value of each first light-emitting region 12 illustrated in graph G12 by the above-described transmittance and the luminance value of each second light-emitting region 13 illustrated in graph G13.

For example, as illustrated in FIG. 5, the luminance value of each subpixel 14 increases as the gray scale value increases in the input gray scale range, and the luminance value of each subpixel 14 with respect to the gray scale value is continuous regardless of the gray scale value. Thus, luminance control of each subpixel 14 is simply achieved by the control of the gray scale. In the present embodiment, the luminance value of the first light-emitting region 12 in the low gray scale range GL and the luminance value of the first light-emitting region in the threshold gray scale GS may be determined so as to satisfy the above.

### Display Device: Control Unit: Gray Scale Converter

Referring back to FIG. 1, the data signal DS is input to each of the first gray scale converter 22 and the second gray scale converter 23. The first gray scale converter 22 and the second gray scale converter 23 convert input data signal DS and output to each of the first source driver 20 and the second source driver 21.

For example, a look-up table in which the strength of the input data signal DS and the strength of the output data signal DS are associated with each other is stored in advance in each of the first gray scale converter 22 and the second gray scale converter 23. Each of the first gray scale converter 22 and the second gray scale converter 23 converts the strength of the input data signal DS by referencing the look-up table. Accordingly, the first gray scale converter 22 and the second gray scale converter 23 perform gray scale conversion of the input data signal DS.

When the data signal DS having a gray scale value in the low gray scale range GL is input, the first gray scale converter 22 performs gray scale conversion of converting the gray scale of the data signal DS to the high gray scale side. The first source driver 20 drives each first light-emitting region 12 using the converted gray scale converted by first gray scale converter 22. Thus, the first light-emitting region 12 is driven such that the luminance change ratio in the low gray scale range GL is greater than the luminance change ratio in the high gray scale range GH.

When the data signal DS having a gray scale value in the low gray scale range GL is input, the second gray scale converter 23 performs gray scale conversion of converting the gray scale of the data signal DS to zero gray scale. Thus, when the gray scale value is in the low gray scale range GL, the second source driver 21 drives each second light-emitting region 13 at a zero gray scale obtained by the gray scale conversion described above, in other words, causes each second light-emitting region 13 to not emit light. Thus, the second light-emitting region 13 is driven so as to not emit light in the low gray scale range GL.

### Summary of First Embodiment

The display device 1 according to the present embodiment includes the display portion 2, including the subpixel 14 including the first light-emitting region 12 and the second light-emitting region 13, and the control unit 3 that controls the display portion 2. When a gray scale in the low gray scale range GL, which is greater than the zero gray scale G0 and less than the threshold gray scale GS, is input to the subpixel 14, the control unit 3 causes the first light-emitting region 12 to emit light without causing the second light-emitting region 13 to emit light. When a gray scale in the high gray scale range GH equal to or greater than the threshold gray scale GS is input to the subpixel 14, the control unit 3 causes the first light-emitting region 12 and the second light-emitting region 13 to emit light.

Thus, in the display device 1, the luminance of the first light-emitting region 12 is increased in the subpixel 14 to which the gray scale of the low gray scale range GL is input compared to a case where both the first light-emitting region 12 and the second light-emitting region 13 emit light. Thus, even when a gray scale in the low gray scale range GL is input to the subpixel 14, the display device 1 can reduce the instability of the luminance of the first light-emitting region 12 caused by causing the first light-emitting region 12 to emit light at high luminance.

Thus, the display device 1 can stably perform low gray scale display. The display device 1 can perform low gray scale display by only adjusting the luminance of each light-emitting region, with the driving method of the subpixel 14 not needing to be changed. Thus, the display device 1 can perform low gray scale display more stably while reducing an increase in cost, a reduction in light-emitting area, and complexity in light emission control of each subpixel 14.

When the gray scale input to the subpixel 14 is in the high gray scale range GH, the display device 1 causes both the first light-emitting region 12 and the second light-emitting region 13 to emit light. Thus, the display device 1 can efficiently increase the luminance of the subpixel 14 in the high gray scale display and reduce a lack of luminance of the subpixel 14 while stabilizing the low gray scale display.

In particular, the display device 1 includes the light-emitting element 102 in each of the first light-emitting region 12 and the second light-emitting region 13. In general, the luminance of the light-emitting element 102 tends to be unstable when the light-emitting element 101 is driven with a low current such as a current at or near the light emission threshold current. The luminance instability is more significant in the case where the light-emitting element 102 includes, as a light-emitting material, an organic light-emitting material or a quantum dot light-emitting material that emits light by injection of holes and electrons. Thus, the display device 1 can efficiently reduce the instability of the luminance of each first light-emitting region 12 due to the driving of the light-emitting element 102 of each first light-emitting region 12 with a low current.

In the present embodiment, the threshold gray scale GS may be set according to the current-luminance characteristics of the light-emitting element 102. For example, the threshold gray scale GS may be a gray scale at which a luminance is obtained at which the instability of the light emission luminance of the subpixel 14 is sufficiently low even when both the first light-emitting region 12 and the second light-emitting region 13 are caused to emit light. This allows the display device 1 to more efficiently reduce the instability of the light emission luminance of the light-emitting element 102.

In the present embodiment, the first light-emitting region 12 and the second light-emitting region 13 are layered on each other. Thus, the display device 1 can secure two light-emitting regions, the first light-emitting region 12 and the second light-emitting region 13, while suppressing a decrease in the resolution of the display portion 2. The second light-emitting region 13 is located more to the viewing side than the first light-emitting region 12. Thus, when the first light-emitting region 12 and the second light-emitting region 13 are caused to emit light at the same luminance, the intensity of light visually seen from the first light-emitting region 12 is less than that of light visually seen from the second light-emitting region 13 due to attenuation of light from the first light-emitting region 12. Thus, the display device 1 can increase the light emission intensity by causing only the first light-emitting region 12 to emit light in the low gray scale range GL, compared to the case where only the second light-emitting region 13 emits light. Thus, the display device 1 further enhances the stability of the luminance of the first light-emitting region 12 and more efficiently reduces the instability of low gray scale display.

However, the relationship between gray scale value and luminance in each light-emitting region is not limited to the relationship illustrated in FIG. 4. For example, the control unit 3 may control the display portion 2 so that the first light-emitting region 12 does not emit light and the second light-emitting region 13 emits light more intensely in the low gray scale range GL. In this case, the control unit 3 may realize the control by exchanging the details of the gray scale conversion in the first gray scale converter 22 and the second gray scale converter 23 with each other.

In the present embodiment, the threshold gray scale GS is in the low gray scale range GL that is lower than the central gray scale GC of the input gray scale range. Thus, the threshold gray scale GS is set so as to improve the luminance of each light-emitting region in a low gray scale range in which the stability of the luminance of each light-emitting region in the input gray scale range tends to decrease. Thus, the display device 1 more efficiently enhances the stability of the luminance of each light-emitting region.

In the present embodiment, the change in the luminance of the first light-emitting region 12 with respect to the change in the gray scale value in the low gray scale range GL is greater than the change in the luminance of each of the first light-emitting region 12 and the second light-emitting region 13 with respect to the change in the gray scale value in the high gray scale range GL. Thus, the display device 1 further improves the luminance of the first light-emitting region 12 in the low gray scale range GL and further enhances the stability of the luminance of the first light-emitting region 12 in the low gray scale range GL.

In the present embodiment, the luminance of the first light-emitting region 12 at the threshold gray scale GS is less than the luminance of the first light-emitting region 12 at a predetermined gray scale in the low gray scale range GL. Thus, the display device 1 further improves the luminance of the first light-emitting region 12 at the predetermined gray scale described above or greater in the low gray scale range GL and further enhances the stability of the luminance of the first light-emitting region 12 in the low gray scale range GL.

The control unit 3 controls light emission of each of the first light-emitting region 12 and the second light-emitting region 13 using gray scale conversion in each of the first gray scale converter 22 and the second gray scale converter 23. Thus, the display device 1 can more easily change the light emission control of each light-emitting region with the threshold gray scale GS as a boundary while reducing the complexity in the control of each driver or the like.

### Second Embodiment

### Multi-Pixel Arrangement

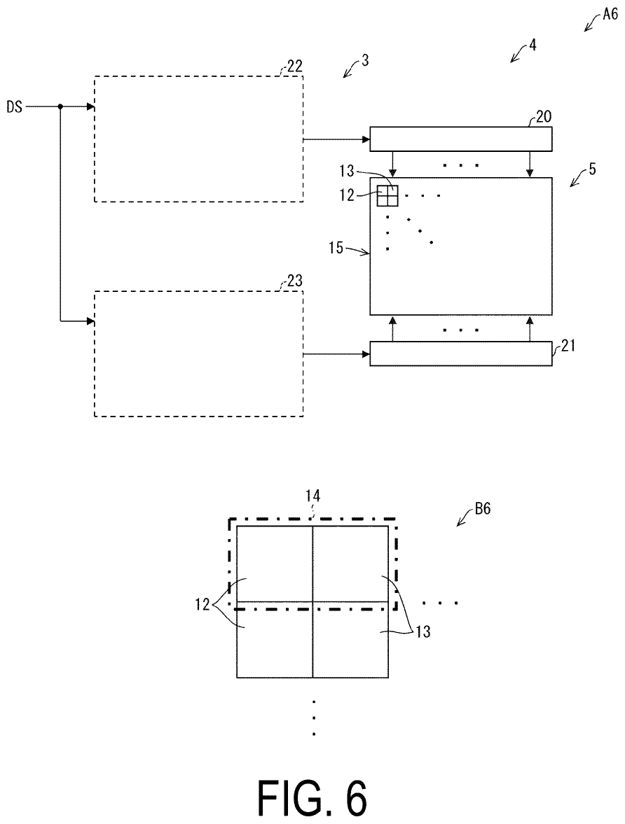

FIG. 6 illustrates a schematic view A6 of a display device 4 according to the present embodiment and a schematic view B6 of a light-emitting region described later. The display device 4 according to the present embodiment differs in configuration from the display device 1 according to the previous embodiment only in that it includes a display portion 5 instead of the display portion 2 as illustrated in schematic view A1.

The display portion 5 includes a display panel 15. The plurality of first light-emitting regions 12 and second light-emitting regions 13 two dimensionally arranged are formed on the display panel 15. Except for the formation position, the first light-emitting regions 12 and the second light-emitting regions 13 according to the present embodiment have the same configurations as the first light-emitting regions 12 and the second light-emitting regions 13 according to the previous embodiment. For example, in schematic view B6, a portion of the first light-emitting region 12 and the second light-emitting region 13 of the display panel 15 is extracted and illustrated.

Thus, in the present embodiment, the first light-emitting region 12 and the second light-emitting region 13 are adjacent to each other in the planar direction. In particular, in the present embodiment, a set including one first light-emitting region 12 and one second light-emitting region 13 adjacent to each other corresponds to the subpixel 14. Thus, in the present embodiment, the subpixels 14 are two dimensionally arranged on the display panel 15.

The control unit 3 controls the display portion 5 to perform display control of the display panel 15. In particular, the control unit 3 controls the luminance of the first light-emitting region 12 via the first source driver 20 and the luminance of the second light-emitting region 13 via the second source driver 21. The relationship between the gray scale value and the luminance in each light-emitting region according to the present embodiment is the same as the relationship described in the previous embodiment. The luminance of the subpixel 14 according to the present embodiment is the sum of the luminance of one first light-emitting region 12 and the luminance of one second light-emitting region 13 included in the subpixel 14. Thus, the relationship between the gray scale value and the luminance in each subpixel 14 according to the present embodiment is the same as the relationship described in the previous embodiment.

Thus, in the display device 4 according to the present embodiment, the first light-emitting region 12 emits light and the second light-emitting region 13 does not emit light in the low gray scale range GL, as in the display device 1 according to the previous embodiment. Thus, the display device 4 can perform a low gray scale display more stably while reducing an increase in cost, a reduction in light-emitting area, and complexity in light emission control of each subpixel 14 for the same reason as that described in the previous embodiment.

Since the first light-emitting region 12 and the second light-emitting region 13 according to the present embodiment are adjacent to each other in the planar direction, the display device 4 does not require a structure for layering the first light-emitting region 12 and the second light-emitting region 13, such as a layered structure of a plurality of display panels. In addition, since the display device 4 extracts light from the first light-emitting region 12 from the display panel 15 without transmitting the light through another display panel or the like, attenuation of light from the first light-emitting region 12 can be reduced. Thus, the display device 4 improves the extraction efficiency of light from each light-emitting region while simplifying the structure.

### Third Embodiment

### Digital-to-Analog Conversion Circuit

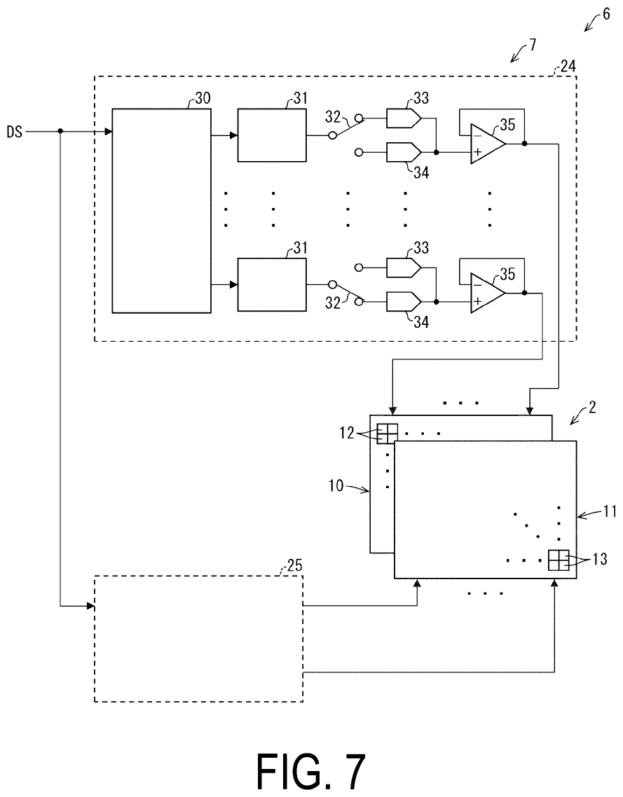

FIG. 7 is a schematic view of a display device 6 according to the present embodiment. The display device 6 according to the present embodiment differs in configuration from the display device 1 according to the first embodiment only in that it includes a control unit 7 instead of the control unit 3 as illustrated in FIG. 7.

The control unit 7 includes, as a first digital-to-analog conversion circuit, a first source driver 24 that is a source driver of the lower display panel 10. The control unit 7 includes, as a second digital-to-analog conversion circuit, a second source driver 25 that is a source driver of the upper display panel 11. In particular, the first source driver 24 controls the luminance of each first light-emitting region 12, and the second source driver 25 controls the luminance of each second light-emitting region 13.

The first source driver 24 includes a shift register 30, a latch circuit 31, a switch 32, a low gray scale range D/A converter 33, a high gray scale range D/A converter 34, and an operational amplifier 35. In particular, the first source driver 24 includes the latch circuit 31, the switch 32, the low gray scale range D/A converter 33, the high gray scale range D/A converter 34, and the operational amplifier 35 for each source line.

In the present embodiment, the data signal DS is input to the shift register 30. A clock signal, a latch signal, or the like may be input to the shift register 30. The shift register 30 inputs a signal corresponding to each source line to the latch circuit 31, thereby latching data corresponding to each source line in each latch circuit 31.

Each latch circuit 31 that has latched the data signal DS inputs the data signal DS to one of the low gray scale range D/A converter 33 and the high gray scale range D/A converter 34 via the switch 32. Here, the switch 32 is switched on the basis of the data of the gray scale value of the data signal DS latched by the corresponding latch circuit 31. In particular, when the gray scale value of the data signal DS latched by the latch circuit 31 is in the low gray scale range GL, the first source driver 24 controls the switch 32 so that the data signal DS is input from the latch circuit 31 to the low gray scale range D/A converter 33. On the other hand, when the gray scale value of the data signal DS latched by the latch circuit 31 is in the high gray scale range GH, the first source driver 24 controls the switch 32 so that the data signal DS is input from the latch circuit 31 to the high gray scale range D/A converter 34.

The low gray scale range D/A converter 33 and the high gray scale range D/A converter 34 are D/A converters that convert digital data relating to the gray scale value of the input data signal DS into analog data relating to the corresponding luminance. Here, the low gray scale range D/A converter 33 converts the data signal DS on the basis of the relationship between the gray scale value and the luminance in the low gray scale range GL. The high gray scale range D/A converter 34 converts the data signal DS on the basis of the relationship between the gray scale value and the luminance in the high gray scale range GH.

The data signal DS converted by the low gray scale range D/A converter 33 or the high gray scale range D/A converter 34 is input to a non-inverting input terminal of the operational amplifier 35. The output of the operational amplifier 35 is fed back to an inverting input terminal of the operational amplifier 35. Thus, the operational amplifier 35 adjusts the strength of the data signal DS output from the low gray scale range D/A converter 33 or the high gray scale range D/A converter 34.

The data signal DS output from the operational amplifier 35 is input to the corresponding source line of the lower display panel 10. Accordingly, the first source driver 24 controls the luminance of first light-emitting region 12 so as to satisfy the relationship between the gray scale value and the luminance as illustrated in graph G12 in FIG. 4, for example.

The second source driver 25 has the same configuration as first source driver 24. However, the low gray scale range D/A converter 33 of the second source driver 25 uniformly converts the luminance values of the input data signals DS to 0. Accordingly, the second source driver 25 controls the luminance of second light-emitting region 13 so as to satisfy the relationship between the gray scale value and the luminance as illustrated in graph G13 in FIG. 4, for example.

As described above, in the display device 6 according to the present embodiment, the first light-emitting region 12 emits light and the second light-emitting region 13 does not emit light in the low gray scale range GL, as in the display device according to the previous embodiments. Thus, the display device 6 can perform a low gray scale display more stably while reducing an increase in cost, a reduction in light-emitting area, and complexity in light emission control of each subpixel 14 for the same reason as described above.

The control unit 3 of the display device 6 controls the display portion 2 by using the first digital-to-analog conversion circuit corresponding to the first light-emitting region 12 and the second digital-to-analog conversion circuit corresponding to the second light-emitting region 13. Thus, the display device 6 does not need a device for performing gray scale conversion of the data signal DS and realizes display control of the display portion 2 by the control unit 3 with a simpler configuration.

The disclosure is not limited to the embodiments described above, and various modifications may be made within the scope of the claims. Embodiments obtained by appropriately combining technical approaches disclosed in the different embodiments also fall within the technical scope of the disclosure. Furthermore, novel technical features can be formed by combining the technical approaches disclosed in the embodiments.

### REFERENCE SIGNS LIST

1, 4, 6 Display device
2, 5 Display portion
3, 7 Control unit
12 First light-emitting region
13 Second light-emitting region
14 Subpixel
20 First source driver
21 Second source driver
22 First gray scale converter
23 Second gray scale converter
24 First source driver (first digital-to-analog conversion circuit)
25 Second source driver (second digital-to-analog conversion circuit)
102 Light-emitting element
106 Light-emitting layer
109 Pixel circuit
GS Threshold gray scale
G0 Zero gray scale
GC Central gray scale

1. A display device comprising:
a display portion including a subpixel including a first light-emitting region and a second light-emitting region; and
a control unit configured to control the display portion to cause the second light-emitting region to not emit light and to cause the first light-emitting region to emit light in a case where a gray scale greater than a zero gray scale and less than a threshold gray scale is input to the subpixel and to cause the first light-emitting region and the second light-emitting region to emit light in a case where a gray scale equal to or greater than the threshold gray scale is input to the subpixel,
wherein the first light-emitting region and the second light-emitting region are stacked on one another, and the second light-emitting region is located more to a viewing side than the first light-emitting region.

2. (canceled)

3. The display device according to claim 1,
wherein the threshold gray scale is less than a central gray scale of an input gray scale range excluding the zero gray scale.

4. The display device according to claim 3,
wherein a luminance change ratio of the first light-emitting region corresponding to an input gray scale range greater than the zero gray scale and less than the threshold gray scale is greater than a luminance change ratio of the first light-emitting region corresponding to an input gray scale range equal to or greater than the threshold gray scale and less than the central gray scale.

5. The display device according to claim 3,
wherein a luminance change ratio of the first light-emitting region corresponding to an input gray scale range greater than the zero gray scale and less than the threshold gray scale is greater than a luminance change ratio of the second light-emitting region corresponding to an input gray scale range equal to or greater than the threshold gray scale and less than the central gray scale.

6. The display device according to claim 1,
wherein a luminance of the first light-emitting region in a case where the threshold gray scale is input to the subpixel is less than a luminance of the first light-emitting region in a case where a predetermined gray scale greater than the zero gray scale and less than the threshold gray scale is input to the subpixel.

7. The display device according to claim 1,
wherein the control unit causes the first light-emitting region to emit light using a converted gray scale obtained by converting an input gray scale greater than the zero gray scale and less than the threshold gray scale to a high gray scale side.

8. The display device according to claim 1,
wherein the control unit causes the second light-emitting region to not emit light using another zero gray scale obtained by converting an input gray scale greater than the zero gray scale and less than the threshold gray scale.

9. The display device according to claim 1, further comprising:
a first digital-to-analog conversion circuit corresponding to the first light-emitting region and a second digital-to-analog conversion circuit corresponding to the second light-emitting region.

10. The display device according to claim 1,
wherein the first light-emitting region and the second light-emitting region are adjacent to one another in a planar direction.

11. The display device according to claim 1,
wherein each of the first light-emitting region and the second light-emitting region includes a light-emitting element, and
the light-emitting element includes an organic light-emitting layer or a quantum dot light-emitting layer.

12. The display device according to claim 11,
wherein the threshold gray scale is set according to current-luminance characteristics of the light-emitting element.

13. The display device according to claim 1,
wherein the subpixel includes a first pixel circuit configured to control light emission in the first light-emitting region and a second pixel circuit configured to control light emission in the second light-emitting region.

14. The display device according to claim 1,
wherein each of the first light-emitting regions and each of the second light-emitting regions are located at positions overlapping one another in a viewing direction.
